(19) United States
(12) Patent Application Publication
(10) Pub. No.: US 2014/0193005 A1
(43) Pub. Date: Jul. 10, 2014

(54) Audio Speaker System with Semi-Shared Passive Radiators

(71) Applicant: Jason R. RIGGS, Las Vegas, NV (US)

(72) Inventor: Jason R. RIGGS, Las Vegas, NV (US)

(21) Appl. No.: 13/735,829

(22) Filed: Jan. 7, 2013

(51) Int. Cl. H04R 1/28; H04R 5/02

(52) U.S. Cl. CPC H04R 1/28; H04R 5/02
USPC 381/300; 381/351

(57) ABSTRACT

A multi-channel stereo speaker system includes acoustically separated but mechanically connected chambers containing active drivers to reproduce sound for each channel, and a passive radiator for each chamber to help tune the frequency response of the chamber. Passive radiators are positioned and oriented so that their movements tend to cancel each other out.

### CONTINUITY AND CLAIM OF PRIORITY

This is an original U.S. patent application.

### FIELD

The invention relates to audio speaker systems. More specifically, the invention relates to acoustic cabinet layouts and arrangements of active drivers and passive radiators in a single-unit multichannel speaker system.

### BACKGROUND

Contemporary advances in electronics and materials have led to the development of smaller and thinner devices whose capabilities nevertheless surpass earlier technological generations. In addition, “entertainment” features (music/audio and video reproduction) are increasingly sought after, and expected to be present in a wider range of products.

One casualty of the “smaller, thinner” trend is sound quality—sound reproduction presently requires that air be physically forced into motion, a task that is made more difficult as the actuators (speakers) that move the air become smaller and more constrained within thinner products.

Structures and techniques that make the most of the diminishing space available for audio reproduction can improve sound quality and may be of significant value in the market.

### SUMMARY

Embodiments of the invention use traditional speaker components—active drivers and passive radiators in tuned enclosures—in a new configuration that allows some components to do double duty by dampening, opposing or cancelling undesired mechanical vibrations.

### BRIEF DESCRIPTION OF DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

FIG. 1 shows a representative embodiment of the invention.

FIGS. 2, 3 and 4 show alternative arrangements of components in an embodiment.

FIG. 5 is a perspective view of the embodiment of FIG. 4.

FIGS. 6 and 7 show new product designs incorporating embodiments of the invention.

### DETAILED DESCRIPTION

Embodiments of the invention provide improved performance in multi- channel loudspeaker systems. For clarity of illustration and description, only two-channel (stereo) systems will be considered in detail, but those of skill in the art will recognize that the principles outlined in the stereo case are easily generalized to the n-channel case (n>2). Thus, multi-channel speaker systems such as “5.1,” “7.1” and “14.2” systems (having five, seven or fourteen audio and “surround” sound channels, and one or two low-frequency, “effects” channels) can also apply the ideas presented here.

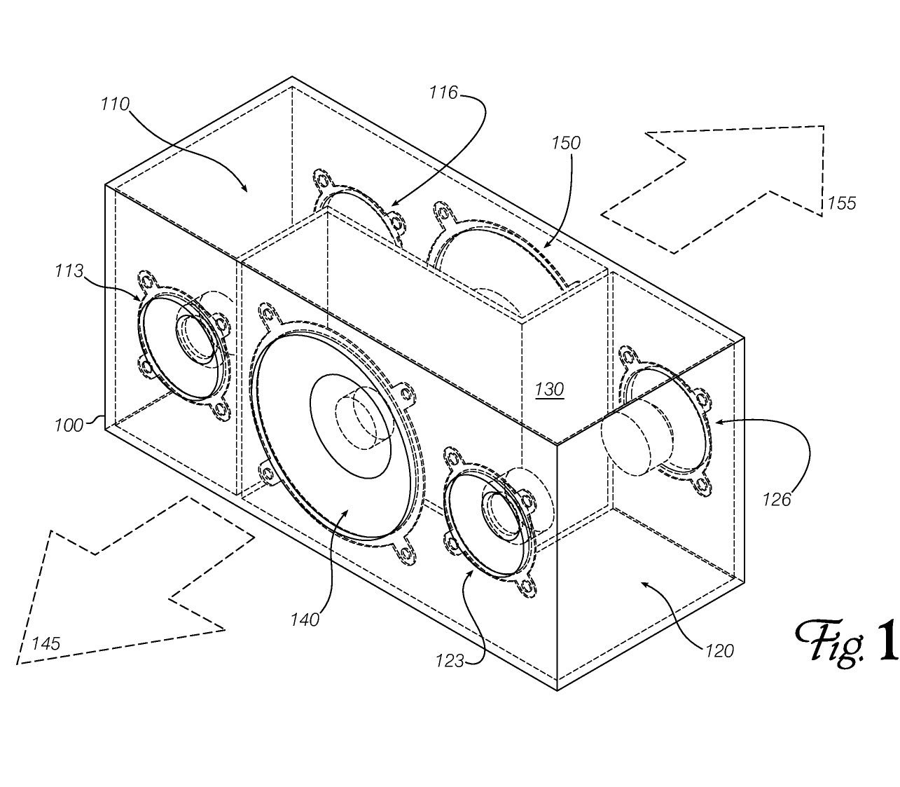

FIG. 1 shows a stereo speaker cabinet that implements an embodiment of the invention. The cabinet comprises a rectangular enclosure 100 whose interior is divided into left and right “L”-shaped chambers 110, 120 by a separating wall 130. Each chamber is fitted with two active drivers (113, 116; 123, 126) to emit sound from the front and back of the speaker, respectively.

Each chamber also has a single passive radiator 140, 150. Passive radiators are often constructed similarly to active loudspeakers, but they lack a speaker's voice coil and magnet, so they do not convert electrical energy in an audio signal into audible sound waves. Instead, they respond to pressure changes within their respective chambers by moving in and out, thus varying the volume of the chamber without allowing a significant amount of air to flow into or out of the chamber. The volume difference and frequency response of a radiator can be altered by adjusting the mass and stiffness of the radiator cone (diaphragm), the compliance of the cone bearing and the size of the radiator, among other parameters. Using a passive radiator, an effect similar to a tuned open port can be obtained, providing improved low-frequency sound reproduction without the typically large and/or long resonant area required by a tuned port.

In an embodiment of the invention, the centerlines of the passive radiators are substantially parallel, and often superimposed upon one another, but the radiators are oriented in opposite directions, as indicated by dashed arrows 145 and 155. Thus, the physical movements of each radiator, caused (principally) by pressure changes within its own chamber, act to dampen, oppose and/or partially cancel the inertial effects of movements of the other (or another) radiator, while still providing the pressure-modulating effect to its chamber.

In an embodiment, the two (or more) chambers are physically linked, but acoustically separated, and the passive radiators are positioned and oriented so that their movements tend to cancel each other out mechanically. Since each chamber typically reproduces a separate audio channel, each radiator's primary impetus is provided by the active drivers for that channel in the chamber, but the radiators have their largest effect at lower frequencies, which tend to be more similar between audio channels. Therefore, the opposed radiators tend to dampen mechanical forces that could otherwise cause the speaker unit to move or vibrate in undesirable ways.

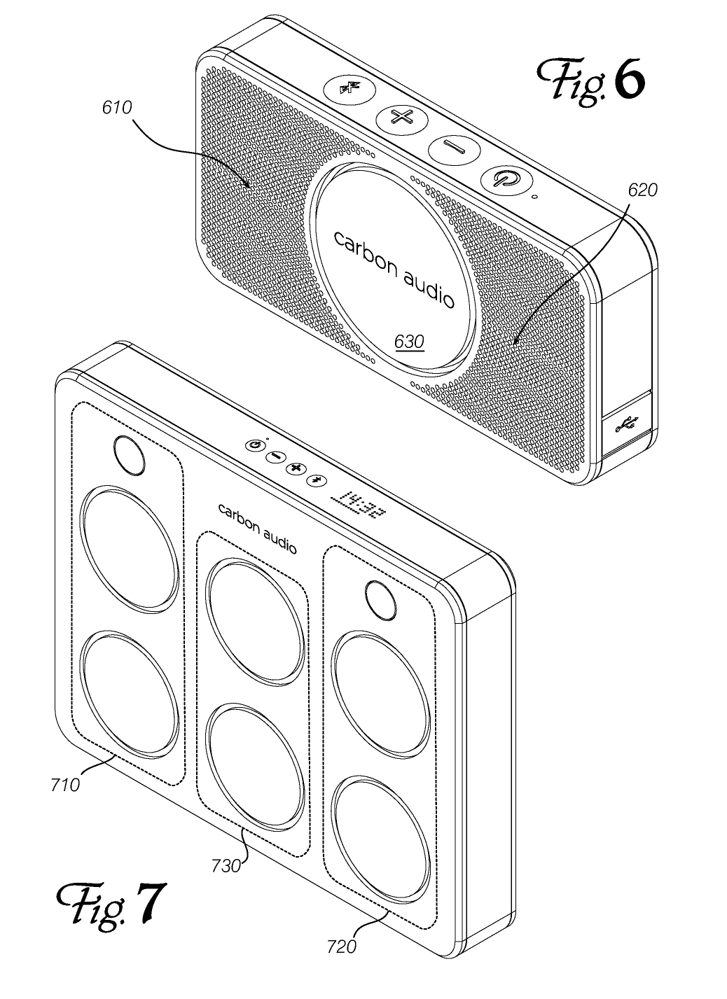

An embodiment may include a mixing network or active signal processor to combine, mix or average lower-frequency portions of the signals from the separate channels before sending the channel signals to the active drivers, so that the passive radiators' movements are more closely synchronized, and therefore so that their opposed motions come closer to complete cancellation. It is appreciated that such mixing may technically degrade stereo separation, but higher frequency sounds are much more important to listeners' perception of audio separation, so the mixing of lower frequencies has little practical impact on the listening experience. Mixing networks are not shown in these Figures, as they are well-known in the art and can be constructed in a number of different ways to fit in the areas available to house them. For example, in portable auxiliary speaker enclosures like the ones shown in FIGS. 6 and 7, the mixing network may be part of an overall control electronics module, which also performs functions such as volume control, frequency-response adjustment, battery management and/or input-source selection.

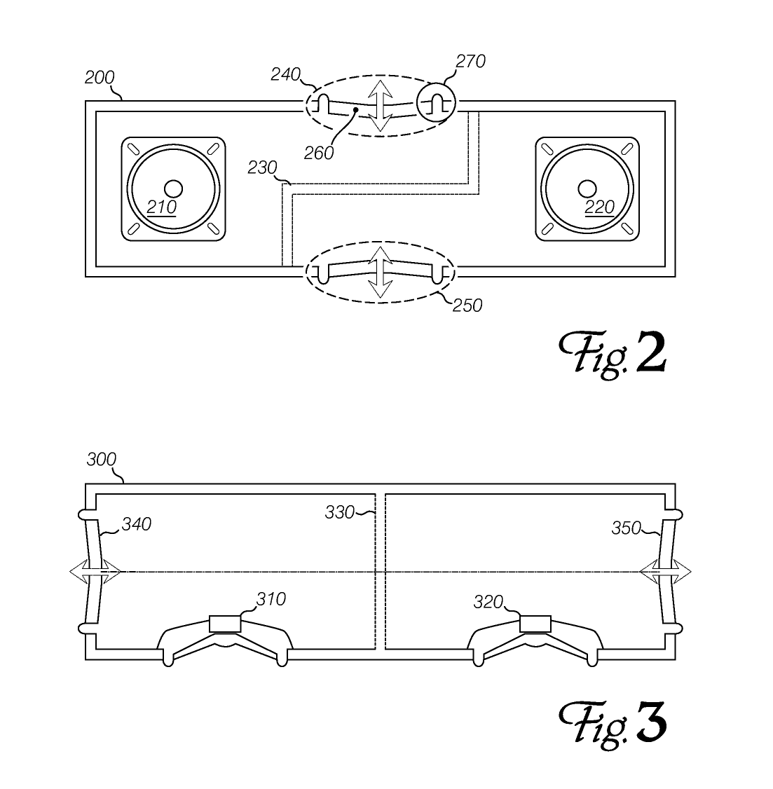

The passive radiators in the embodiment of FIG. 1 face the front and back of the speaker cabinet. However, since the radiators' function is not principally to project sound to the listener, they may be oriented differently in an embodiment. FIGS. 2, 3 and 4 show simplified views of three possible configurations for two-channel (stereo) speakers. In FIG. 2, the speaker enclosure 200 is seen from the front, with left- and right-channel active drivers 210, 220 facing forward. An internal partition 230 divides the enclosure into two acoustically separate chambers, and passive radiators 240 and 250 are located on the top and bottom of the enclosure, respectively. The passive radiators are shown in sectional profile, with a slightly indented/conical diaphragm 260 and U-shaped cone bearing 270. (The cone bearing is usually a thin, flexible, resilient membrane that may be U-shaped, as shown here, or have a wavy/accordion shape. Its purpose is to allow the radiator cone to move in and out along its axis.) The passive radiators' central axes are aligned, but they are oriented in opposite directions.

FIG. 3 is a top view of another embodiment, showing the enclosure 300 and partition divider 330 separating the enclosure into left and right chambers. Active drivers on the front of the enclosure are at 310 and 320. In some embodiments, each chamber may have several drivers (for example, tweeter and midrange drivers to reproduce different ranges of frequencies), or multiple identical drivers to move more air for louder play. In this embodiment, the passive radiators for each chamber 340, 350 are located at the ends of the enclosure, facing outward but with their central axes aligned and coincident.

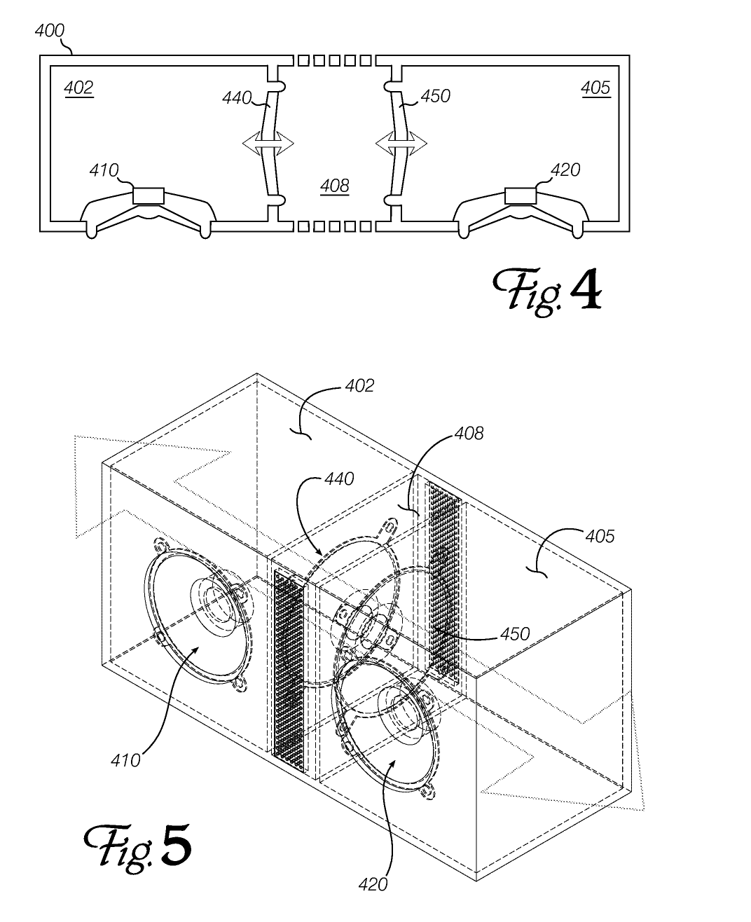

FIG. 4 shows yet another possible arrangement of a speaker system according to an embodiment of the invention. Here, enclosure 400 has two acoustic chambers 402, 405 that are separated by a vented chamber 408. Thus, in this embodiment, the two acoustic chambers do not share a common partition, as in the other illustrated embodiments. Each acoustic chamber is provided with at least one active driver 410, 420, and the passive radiators 440, 450 are located on inner walls of their respective acoustic chambers, facing inward. As in other embodiments, the central axes of the passive radiators are aligned, but the radiators face in opposite directions. FIG. 5 is a perspective view of this embodiment with the same features identified.

FIGS. 6 and 7 show renderings of new product designs implementing embodiments of the invention. In the design shown in FIG. 6, the left and right-channel active drivers are behind the grille near locations indicated by 610 and 620, while the large circular area 630 (and a corresponding area on the back surface of the unit, not visible in this view) is a passive radiator. In FIG. 7, active drivers from both channels and the front passive radiators are visible at 710, 720 and 730, respectively. Of course, this embodiment also comprises passive radiators on the back. The rear-facing radiators' central axes are aligned with the front radiators, but they face in opposite directions.

The applications of the present invention have been described largely by reference to specific examples and in terms of particular arrangements of components. However, those of skill in the art will recognize that speaker systems can use shared, mechanically-coupled passive radiators to reduce unwanted vibration and movement in other configurations as well. Such alternate configurations and arrangements are understood to be captured according to the following claims.

I claim:

1. A multi-channel loudspeaker comprising:
an enclosure subdivided into a plurality of separate chambers;
a plurality of active drivers, one active driver in each of the separate chambers; and
a plurality of passive radiators, one passive radiator in each of the separate chambers, wherein
the passive radiators are oriented so that physical movement of a first passive radiator in a first separate chamber is at least partially counterbalanced by physical movement of at least a second passive radiator in a second, different separate chamber.

2. The multi-channel loudspeaker of claim 1, further comprising:
an audio signal processing network to mix low-frequency portions from each of a plurality of channels so that audio signals to be reproduced by the plurality of active drivers have similar low-frequency portions.

3. The multi-channel loudspeaker of claim 2 wherein the audio signal processing network is a passive network.

4. The multi-channel loudspeaker of claim 2 wherein the audio signal processing network is an active network.

5. The multi-channel loudspeaker of claim 1 wherein a first passive radiator faces a top of the enclosure, and a second passive radiator faces a bottom of the enclosure.

6. The multi-channel loudspeaker of claim 1 wherein a first passive radiator faces a left outside of the enclosure, and a second passive radiator faces a right outside of the enclosure.

7. The multi-channel loudspeaker of claim 1 wherein a first passive radiator faces a front of the enclosure, and a second passive radiator faces a rear of the enclosure.

8. The multi-channel loudspeaker of claim 1 wherein a first chamber is separated from a second chamber by a vented chamber, and wherein
a first passive radiator faces a second passive radiator, both of said passive radiators facing into the vented chamber.

9. The multi-channel loudspeaker of claim 1 wherein the plurality of separate chambers is two separate chambers.

10. The multi-channel loudspeaker of claim 1 wherein the plurality of separate chambers is five separate chambers.

11. A multi-channel loudspeaker comprising:
an enclosure subdivided into a plurality of separate chambers;
a plurality of active drivers, one active driver in each of the separate chambers; and
means for passively tuning a resonant frequency of each of the separate chambers, wherein
action of the means for passively tuning the resonant frequency of a first separate chamber opposes action of the means for passively tuning the resonant frequency of a second separate chamber.

12. The multi-channel loudspeaker of claim 11, further comprising:
a signal mixing network to mix audio signals for a plurality of channels so that low-frequency portions of the signals for each channel become more similar.

13. The multi-channel loudspeaker of claim 11, further comprising:
a signal processor to reduce low-frequency channel separation between audio signals for a plurality of channels.

14. A two-channel (stereo) loudspeaker comprising:
a left-channel chamber with at least one left-channel active driver and at least one left-channel passive radiator;
a right-channel chamber with at least one right-channel active driver and at least one right-channel passive radiator, wherein
the left-channel chamber and the right-channel chamber are mechanically connected but acoustically separated; and
directed centerlines of at least one left-channel passive radiator and at least one right-channel passive radiator are substantially coincident but oriented in opposite directions.

15. The two-channel (stereo) loudspeaker of claim 14 wherein the directed centerline of each passive radiator is parallel to a directed centerline of an active driver of the same channel.

16. The two-channel (stereo) loudspeaker of claim 14 wherein the directed centerline of each passive radiator is perpendicular to a directed centerline of an active driver of the same channel.

17. The two-channel (stereo) loudspeaker of claim 14 wherein the left and right chambers are separated by a sealed partition wall.

18. The two-channel (stereo) loudspeaker of claim 14 wherein the left and right chambers are formed within a single substantially airtight enclosure.

19. The two-channel (stereo) loudspeaker of claim 14 wherein the left and right chambers are separated by a vented chamber.

20. The two-channel (stereo) loudspeaker of claim 14 wherein the left and right chambers are mechanically connected by an outer enclosure of the loudspeaker.
